(19) United States
(12) Patent Application Publication
(10) Pub. No.: US 2025/0392094 A1
(43) Pub. Date: Dec. 25, 2025

(54) LASER AMPLIFIER, LASER APPARATUS, AND ELECTRONIC DEVICE MANUFACTURING METHOD

(71) Applicant: Gigaphoton Inc., Tochigi (JP)

(72) Inventors: Takehito SHIMATSU, Miyagi (JP); Miyuki UOMOTO, Miyagi (JP); Yasuhiro KAMBA, Oyama-shi (JP); Taisuke MIURA, Oyama-shi (JP)

(73) Assignee: Gigaphoton Inc., Tochigi (JP)

(21) Appl. No.: 19/201,213

(22) Filed: May 7, 2025

(30) Foreign Application Priority Data
Jun. 24, 2024 (JP) 2024-101305

(51) Int. Cl. H01S 3/10; H01S 3/04

(52) U.S. Cl. CPC H01S 3/10023; H01S 3/0401; H01S 3/0405; H01S 3/10092

(57) ABSTRACT

A laser amplifier includes a laser amplifying medium having a rectangular cross section perpendicular to an optical path axis of seed light, a pair of metal blocks bonded to two wider opposite surfaces of four surfaces of the laser amplifying medium parallel to the optical path axis, an excitation light source configured to output excitation light that excites the laser amplifying medium, and a collimating lens configured to collimate the excitation light.

### CROSS-REFERENCE TO RELATED APPLICATIONS

The present application claims the benefit of Japanese Patent Application No. 2024-101305, filed on Jun. 24, 2024, the entire contents of which are hereby incorporated by reference.

### BACKGROUND

### 1. Technical Field

The present disclosure relates to a laser amplifier, a laser apparatus, and an electronic device manufacturing method.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser apparatus for exposure, a KrF excimer laser apparatus that outputs a laser beam having a wavelength of about 248 nm and an ArF excimer laser apparatus that outputs a laser beam having a wavelength of about 193 nm are used.

### LIST OF DOCUMENT

### Patent Document

Patent Document 1: U.S. Pat. No. 5,159,605

### SUMMARY

A laser amplifier according to one aspect of the present disclosure includes a laser amplifying medium, a pair of metal blocks, an excitation light source, and a collimating lens. The laser amplifying medium has a cross section in a rectangular shape perpendicular to an optical path axis of seed light. The pair of metal blocks are bonded to two wider opposite surfaces of four surfaces of the laser amplifying medium parallel to the optical path axis. The excitation light source is configured to output excitation light that excites the laser amplifying medium. The collimating lens is configured to collimate the excitation light.

A laser apparatus according to one aspect of the present disclosure includes a seed laser, a laser amplifying medium, a pair of metal blocks, an excitation light source, and a collimating lens. The seed laser is configured to output pulsed seed light. The laser amplifying medium has a cross section in a rectangular shape perpendicular to an optical path axis of the seed light. The pair of metal blocks are bonded to two wider opposite surfaces of four surfaces of the laser amplifying medium parallel to the optical path axis. The excitation light source is configured to output excitation light that excites the laser amplifying medium. The collimating lens is configured to collimate the excitation light.

An electronic device manufacturing method according to one aspect of the present disclosure includes generating a laser beam by a laser apparatus, manufacturing an interposer by laser processing an interposer substrate with the laser beam, coupling and electrically connecting the interposer and an integrated circuit chip to each other, and coupling and electrically connecting the interposer and a circuit board to each other. The laser apparatus includes a seed laser configured to output pulsed seed light, a laser amplifying medium having a cross section in a rectangular shape perpendicular to an optical path axis of the seed light, a pair of metal blocks bonded to two wider opposite surfaces of four surfaces of the laser amplifying medium parallel to the optical path axis, an excitation light source configured to output excitation light that excites the laser amplifying medium, and a collimating lens configured to collimate the excitation light.

### BRIEF DESCRIPTION OF THE DRAWINGS

Some embodiments of the present disclosure will be described below, by way of example only, with reference to the accompanying drawings.

FIG. 1 illustrates a configuration of a laser processing system in a comparative example.

FIG. 2 is a sectional view of an amplification unit in the comparative example.

FIG. 3 illustrates a light intensity distribution of a laser beam when excitation power by excitation light is 0 W in the comparative example.

FIG. 4 illustrates a light intensity distribution of a laser beam when the excitation power by the excitation light is 120 W in the comparative example.

FIG. 5 is a sectional view of an amplification unit in a first embodiment.

FIG. 6 illustrates a light intensity distribution of a laser beam when excitation power by excitation light is 120 W in the first embodiment.

FIG. 7 is a graph illustrating a relationship between excitation power by excitation light and output power of a laser beam in the comparative example and the first embodiment.

FIG. 8 is a sectional view of an amplification unit in a second embodiment.

FIG. 9 schematically illustrates a configuration of an electronic device.

FIG. 10 is a flowchart illustrating an electronic device manufacturing method.

### DESCRIPTION OF EMBODIMENTS

### Contents

1. Comparative Example
1.1 Laser Processing System
1.2 Laser Amplifier 100
   1.2.1 Configuration
   1.2.2 Operation
1.3 Amplification Unit AMP
1.4 Problem of Comparative Example

2. Embodiment in which Cross Section of Laser Amplifying Medium 1b is Rectangular
2.1 Configuration
2.2 Operation
2.3 Effect

3. Embodiment in which Metal Blocks 2a and 2b Include Flow Path 2c
3.1 Configuration and Operation
3.2 Effect

4. Others
4.1 Electronic Device Including Interposer IP
4.2 Supplement

Hereinafter, embodiments of the present disclosure will be described in detail with reference to the drawings. The embodiments described below illustrate some examples of the present disclosure and do not limit contents of the present disclosure. In addition, all configurations and operations described in the embodiments are not necessarily essential as configurations and operations of the present disclosure. Here, the same components are denoted by the same reference signs, and any redundant description thereof is omitted.

### 1. Comparative Example

### 1.1 Laser Processing System

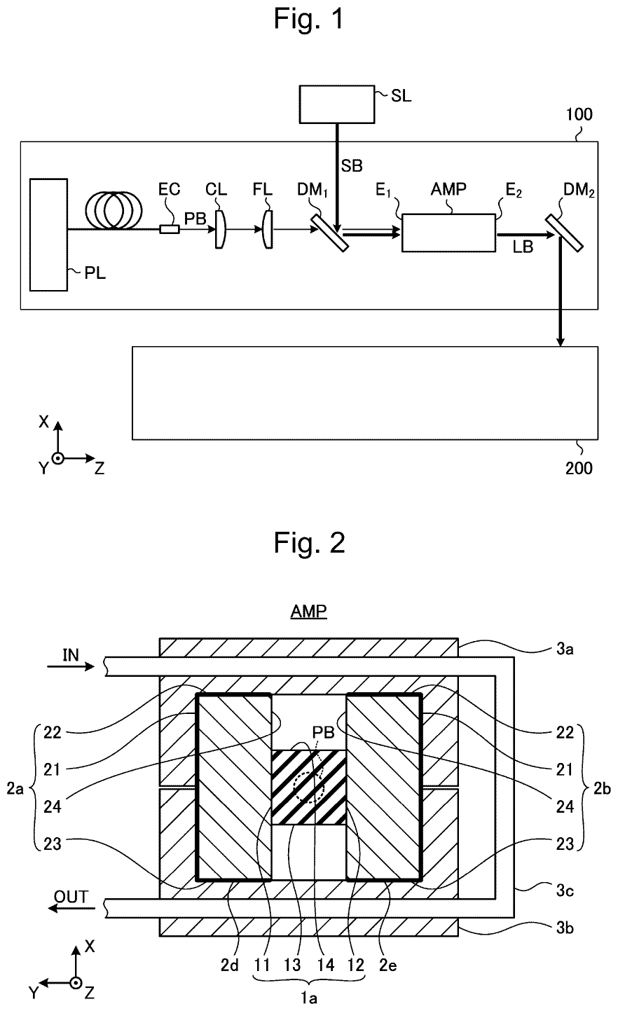

FIG. 1 illustrates a configuration of the laser processing system in a comparative example. The comparative example of the present disclosure is an example recognized by the applicant as known only by the applicant, and is not a publicly known example admitted by the applicant. The laser processing system includes a seed laser SL, a laser amplifier 100, and a laser irradiation device 200.

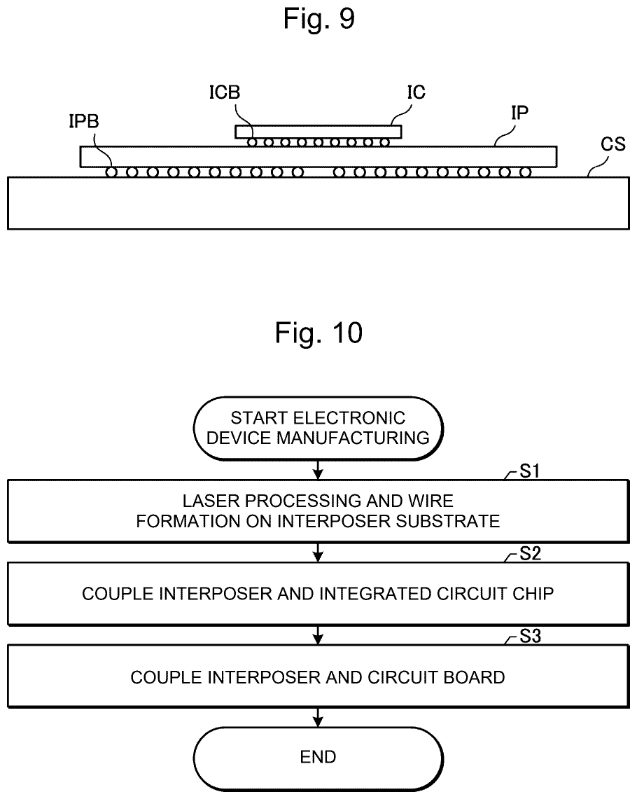

The seed laser SL is a laser oscillator that outputs pulsed seed light SB. A wavelength of the seed light SB is, for example, about 1030 nm. The laser amplifier 100 amplifies the seed light SB and outputs a pulsed laser beam LB. The laser beam LB may be converted into an oscillation wavelength of an unillustrated KrF excimer laser apparatus or ArF excimer laser apparatus by an unillustrated wavelength converter, and be further amplified by such an excimer laser apparatus. The laser irradiation device 200 includes an unillustrated irradiation optical system for irradiating an unillustrated workpiece with the laser beam LB. The workpiece is, for example, an interposer substrate used for manufacturing of an interposer IP that relays an integrated circuit chip IC and a circuit board CS to be described later with reference to FIG. 9.

### 1.2 Laser Amplifier 100

### 1.2.1 Configuration

The laser amplifier 100 includes a pump laser PL, an endcap EC, a collimating lens CL, a focusing lens FL, dichroic mirrors DM₁ and DM₂, and an amplification unit AMP. Although a case where the laser amplifier 100 is a forward pumped laser amplifier is described below, the laser amplifier 100 may be a backward pumped laser amplifier or a double-ended pumped laser amplifier.

The amplification unit AMP includes a laser amplifying medium 1a (see FIG. 2). The laser amplifying medium 1a is, for example, crystals of Yb:YAG (Ytterbium-doped Yttrium Aluminum Garnet).

The pump laser PL is an excitation light source configured to output excitation light PB that excites the laser amplifying medium 1a, and is formed of, for example, a semiconductor laser or a solid-state laser. A wavelength of the excitation light PB is set according to an absorption wavelength of the amplification unit AMP.

When the laser amplifying medium 1a is the Yb:YAG crystal, the wavelength of the excitation light PB is set to either 940 nm or 969 nm.

The endcap EC is disposed at an output end of an optical fiber connected to the pump laser PL.

The collimating lens CL is disposed in an optical path of the excitation light PB output from the endcap EC. A focal length of the collimating lens CL is, for example, 12 mm.

The focusing lens FL is disposed in an optical path of the excitation light PB output from the collimating lens CL. A focal length of the focusing lens FL is, for example, 250 mm.

The dichroic mirror DM₁ is disposed obliquely with respect to an optical path axis of the seed light SB output from the seed laser SL and an optical path axis of the excitation light PB output from the focusing lens FL. The dichroic mirror DM₂ is disposed obliquely with respect to an optical path axis of the laser beam LB output from the amplification unit AMP. The dichroic mirrors DM₁ and DM₂ are configured to reflect wavelength components included in the seed light SB and the laser beam LB and to transmit wavelength components included in the excitation light PB.

### 1.2.2 Operation

The excitation light PB output from the pump laser PL is output as divergent light from the endcap EC. The excitation light PB is converted into parallel light by the collimating lens CL. The excitation light PB output from the collimating lens CL is converted into convergent light by the focusing lens FL. FIG. 1 illustrates only an optical path axis of a light beam.

The excitation light PB output from the focusing lens FL passes through the dichroic mirror DM₁ and is focused on a first end portion E₁ of the laser amplifying medium 1a included in the amplification unit AMP.

The seed beam SB output from the seed laser SL is reflected by the dichroic mirror DM₁ and enters the first end portion E₁. The excitation light PB and the seed light SB entering the amplification unit AMP are preferably coaxial with each other. In the present disclosure, the terms coaxial, parallel, and perpendicular are not limited to being completely coaxial, parallel, and perpendicular, and include tolerances within a practical range, such as within 5°.

The laser amplifying medium 1a included in the amplification unit AMP is excited by energy of the excitation light PB, and amplifies the seed light SB. The amplified seed beam SB is output as the laser beam LB from a second end portion E₂ of the laser amplifying medium 1a. The laser beam LB output from the second end portion E₂ is reflected by the dichroic mirror DM₂ and is output from the laser amplifier 100.

The excitation light PB is, for example, a continuous-wave laser beam. Alternatively, the excitation light PB may be a pulsed laser beam, and in that case, synchronous control that makes pulses of the seed light SB and pulses of the excitation light PB overlap in the amplification unit AMP is performed.

A part of the excitation light PB may be transmitted through the laser amplifying medium 1a and exit from the second end portion E₂. The excitation light PB output from the second end portion E₂ is transmitted through the dichroic mirror DM₂ and enters an unillustrated beam damper.

### 1.3 Amplification Unit AMP

FIG. 2 is a sectional view of the amplification unit AMP in the comparative example. A direction of the optical path axis of the excitation light PB and the seed light SB entering the amplification unit AMP is defined as a Z direction. The cross section illustrated in FIG. 2 is perpendicular to the Z direction. The amplification unit AMP includes the laser amplifying medium 1a, a pair of metal blocks 2a and 2b, and a pair of heat sinks 3a and 3b.

The laser amplifying medium 1a has a quadrangular prism shape that is long in the Z direction. The metal blocks 2a and 2b contain aluminum or copper, each have a quadrangular prism shape, and are disposed in contact with the laser amplifying medium 1a. A length of the metal blocks 2a and 2b in the Z direction is substantially same as a length of the laser amplifying medium 1a in the Z direction. A cross section of the optical path of the excitation light PB that enters the laser amplifying medium 1a coaxially with the seed light SB is illustrated by a broken line in FIG. 2. Heat generated inside the laser amplifying medium 1a by the energy of the excitation light PB is discharged to an outside of the laser amplifying medium 1a by heat conduction to the metal blocks 2a and 2b.

However, since thermal conductivity of the laser amplifying medium 1a is low, it is not desirable to make a distance from the optical path of the excitation light PB, which is a region where the heat inside the laser amplifying medium 1a is generated, to a contact surface with the metal blocks 2a and 2b too long. The length of one side of the cross section perpendicular to the Z direction of the laser amplifying medium 1a is set to, for example, about 2 mm.

It is conceivable to bring all of four surfaces 11 to 14 parallel to the Z direction of the laser amplifying medium 1a into contact with the metal blocks 2a and 2b in order to promote heat discharge to the metal blocks 2a and 2b. However, it is difficult to accurately process the metal blocks 2a and 2b so as to be in close contact with all of the four surfaces 11 to 14 of the laser amplifying medium 1a in which the length of one side of the cross section is about 2 mm, and thermal resistance increases in a case of a close contact defect. Therefore, the metal blocks 2a and 2b are brought into contact only with the two opposite surfaces 11 and 12 of the laser amplifying medium 1a, respectively. An opposing direction of the two surfaces 11 and 12 of the laser amplifying medium 1a in contact with the respective metal blocks 2a and 2b is defined as a Y direction or a −Y direction. A direction parallel to the surfaces 11 and 12 and perpendicular to the Z direction is defined as an X direction or a −X direction.

Each of the metal blocks 2a and 2b has a surface 24 in contact with the laser amplifying medium 1a, a first surface 21 on an opposite side, and second and third surfaces 22 and 23 intersecting the X direction and parallel to the Z direction. The first to third surfaces 21-23 are contact surfaces in contact with the heat sinks 3a and 3b. Indium foil layers 2d and 2e are disposed on the first to third surfaces 21 to 23.

The heat sinks 3a and 3b contain aluminum or copper. The heat sink 3a is located on an X direction side of the metal blocks 2a and 2b, and the heat sink 3b is located on a −X direction side. The heat sink 3a corresponds to a first member in the present disclosure, and the heat sink 3b corresponds to a second member in the present disclosure. The heat sinks 3a and 3b are disposed such that respective rectangular grooves face each other, and surround the metal blocks 2a and 2b. A portion of each of the metal blocks 2a and 2b is accommodated in the groove of the heat sink 3a, and the other portion of each of the metal blocks 2a and 2b is accommodated in the groove of the heat sink 3b. The lengths of the heat sinks 3a and 3b in the Z direction are substantially the same as the lengths of the metal blocks 2a and 2b in the Z direction. Each of the heat sinks 3a and 3b includes a flow path 3c through which a cooling medium, such as cooling water, passes. The flow path 3c is connected to a heat exchanger and a pump that are not illustrated. The cooling medium flows through the flow path 3c as indicated by an arrow IN and an arrow OUT to cool the heat sinks 3a and 3b.

### 1.4 Problem of Comparative Example

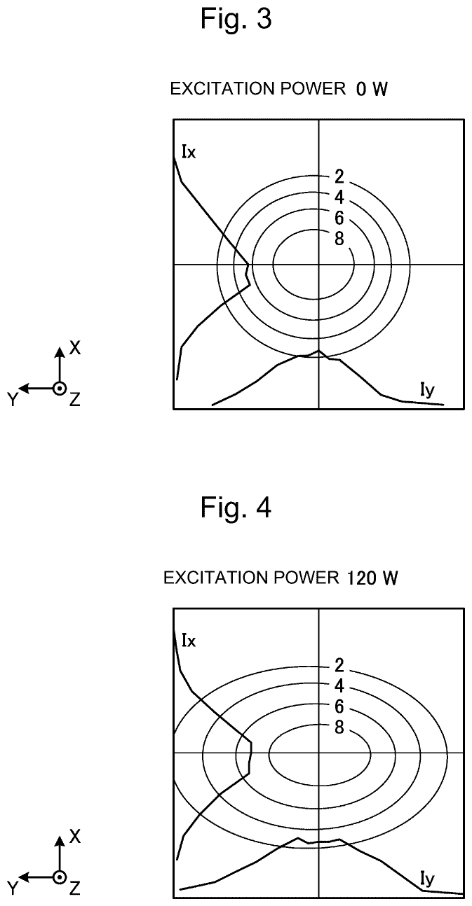

FIG. 3 illustrates a light intensity distribution of the laser beam LB output from the second end portion E₂ when excitation power by the excitation light PB is 0 W in the comparative example. FIG. 4 illustrates the light intensity distribution of the laser beam LB output from the second end portion E₂ when the excitation power by the excitation light PB is 120 W in the comparative example. At a center of each of FIG. 3 and FIG. 4, contour lines of light intensity are illustrated with a relative value scale. A light intensity distribution Iy along the Y direction is illustrated at a lower end of each of FIG. 3 and FIG. 4, and a light intensity distribution Ix along the X direction is illustrated at a left end.

As described above, the metal blocks 2a and 2b are in contact only with the two opposite surfaces 11 and 12 of the laser amplifying medium 1a. Even if air is made to flow along the surfaces 13 and 14, cooling efficiency in the X direction and the −X direction may be inferior to cooling efficiency in the Y direction and the −Y direction of the laser amplifying medium 1a. Therefore, even though heat is efficiently discharged in the Y direction and the −Y direction and a sharp temperature gradient in the Y direction is generated inside the laser amplifying medium 1a, the heat is not likely to be discharged in the X direction and the −X direction, a high-temperature region that is long in the X direction is formed inside the laser amplifying medium 1a, and the temperature gradient in the X direction becomes gentle. When the temperature gradients are different between the Y direction and the X direction, a thermal lens having different refractive indices in the Y direction and in the X direction are formed inside the laser amplifying medium 1a.

When the excitation power is 0 W as illustrated in FIG. 3, since there is almost no temperature gradient, the seed light SB inside the laser amplifying medium 1a is almost not affected by the thermal lens, and the light intensity distribution of the laser beam LB becomes almost circular. When the excitation power becomes 120 W as illustrated in FIG. 4, the contour lines of the light intensity distribution of the laser beam LB are stretched in the Y direction and the −Y direction by the thermal lens in the Y direction.

On the other hand, since the excitation light PB is multimode light, it is less susceptible to the thermal lens. Therefore, there may be a discrepancy between a shape of the optical path of the seed light SB and a shape of the optical path of the excitation light PB inside the laser amplifying medium 1a, and amplification efficiency may decrease.

Embodiments described below are related to suppressing the discrepancy in the shapes of the optical paths of the seed light SB and the excitation light PB and suppressing a decrease in the amplification efficiency by suppressing deformation of the seed light SB due to the thermal lens even when the energy of the excitation light PB becomes high.

### 2. Embodiment in Which Cross Section of Laser Amplifying Medium 1b is Rectangular

### 2.1 Configuration

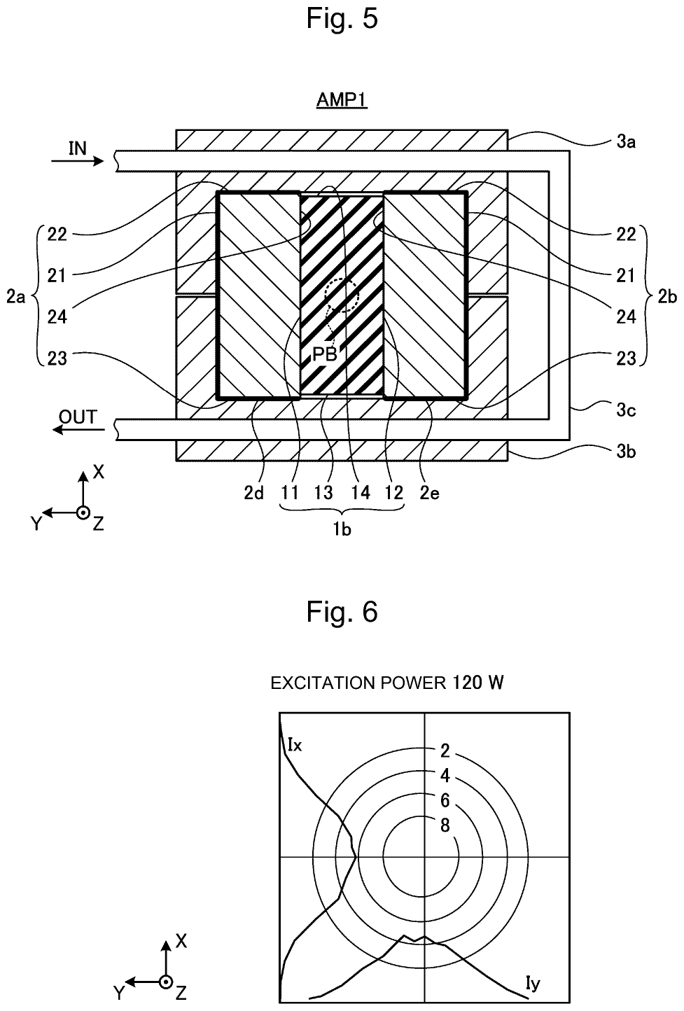

FIG. 5 is a sectional view of an amplification unit AMP1 in a first embodiment. A configuration of the laser amplifier 100 is the same as that in the comparative example except that the amplification unit AMP1 is used instead of the amplification unit AMP.

The amplification unit AMP1 includes a laser amplifying medium 1b instead of the laser amplifying medium 1a. The laser amplifying medium 1b has a cross section in a rectangular shape perpendicular to the Z direction. A length of a long side of the rectangular shape is preferably two times or more and five times or less a length of a short side.

The metal blocks 2a and 2b are bonded to the two wider opposite surfaces 11 and 12 of the four surfaces 11 to 14 of the laser amplifying medium 1b parallel to the Z direction. The length of each of the metal blocks 2a and 2b in the X direction is equal to or greater than the length of the laser amplifying medium 1b in the X direction.

The laser amplifying medium 1b and the metal blocks 2a and 2b may be bonded by any of diffusion bonding, brazing, and soldering, but atomic diffusion bonding is most desirable. It is desirable that the metal blocks 2a and 2b are atomically diffusion-bonded to the entire surfaces 11 and 12. A thickness of an interlayer of the atomic diffusion bonding is about 100 nm. The two narrower opposite surfaces 13 and 14 of the four surfaces 11 to 14 of the laser amplifying medium 1b parallel to the Z direction may be in contact with a gas such as air.

A focusing diameter of the excitation light PB focused by the focusing lens FL is preferably equal to or less than half the length of the short side of the cross section perpendicular to the Z direction of the laser amplifying medium 1b, and is preferably equal to or less than one quarter of the length of the long side. For example, the length of the short side may be set to 2 mm, the length of the long side may be set to 5 mm, and the focusing diameter of the excitation light PB may be set to 0.5 mm. The focusing diameter is a total width of a portion having the light intensity equal to or higher than 1/e² of peak intensity at a focusing position. A total angular value of beam divergence of the excitation light PB focused by the focusing lens FL, expressed in radians, is preferably equal to or less than a value obtained by dividing the length of the short side of the cross section perpendicular to the Z direction of the laser amplifying medium 1b by the length in the Z direction of the laser amplifying medium 1b.

### 2.2 Operation

FIG. 6 illustrates a light intensity distribution of the laser beam LB output from the second end portion E₂ when the excitation power by the excitation light PB is 120 W in the first embodiment. At the center of FIG. 6, the contour lines of the light intensity are illustrated with the relative value scale. The light intensity distribution Iy along the Y direction is illustrated at the lower end of FIG. 6, and the light intensity distribution Ix along the X direction is illustrated at the left end.

According to the first embodiment, since the laser amplifying medium 1b is longer in the X direction than in the Y direction and is in contact with the metal blocks 2a and 2b in a wide range in the X direction, the heat is discharged from the laser amplifying medium 1b to the metal blocks 2a and 2b in the wide range in the X direction. As a result, regions separated from the optical path of the excitation light PB in the X direction and the −X direction are also cooled so that the temperature gradient is generated not only in the Y direction but also in the X direction. Thus, a difference in the temperature gradient between the Y direction and the X direction becomes small, and a difference in the refractive index of the thermal lens between the Y direction and the X direction becomes small.

As illustrated in FIG. 6, even when the excitation power by the excitation light PB is high, the light intensity distribution of the laser beam LB has a shape close to a concentric circle. As a result, it is possible to increase conformity between the shape of the optical path of the seed light SB and the shape of the optical path of the excitation light PB inside the laser amplifying medium 1b and to improve the amplification efficiency.

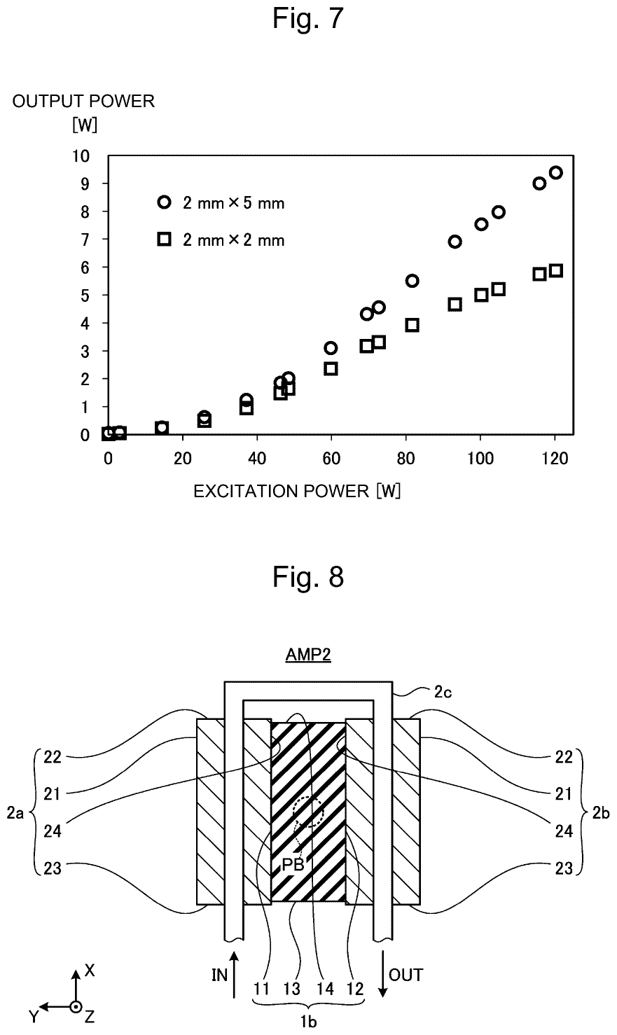

FIG. 7 is a graph illustrating a relationship between the excitation power by the excitation light PB and output power of the laser beam LB in the comparative example and the first embodiment. The cross section perpendicular to the Z direction of the laser amplifying medium 1a in the comparative example is a square of 2 mm×2 mm, and the cross section perpendicular to the Z direction of the laser amplifying medium 1b in the first embodiment is a rectangle of 2 mm×5 mm. There is no large difference in the output power of the laser beam LB between the comparative example and the first embodiment when the excitation power by the excitation light PB is low. However, when the excitation power exceeds 30 W, the output power of the laser beam LB in the first embodiment is remarkably improved. When the excitation power is 120 W, the output power of the laser beam LB in the first embodiment is about 1.5 times that in the comparative example.

In other respects, the first embodiment may be the same as the comparative example.

### 2.3 Effect

(1) According to the first embodiment, the laser amplifier 100 includes the laser amplifying medium 1b having the cross section in a rectangular shape perpendicular to the optical path axis of the seed light SB, the pair of metal blocks 2a and 2b bonded to the two wider opposite surfaces 11 and 12 of the four surfaces 11 to 14 of the laser amplifying medium 1b parallel to the optical path axis of the seed light SB, the pump laser PL that outputs the excitation light PB for exciting the laser amplifying medium 1b, and the collimating lens CL that collimates the excitation light PB.

Accordingly, since the cross section of the laser amplifying medium 1b is rectangular and the metal blocks 2a and 2b are bonded to the two wider opposite surfaces 11 and 12 of the four surfaces 11 to 14, the heat generated inside the laser amplifying medium 1b by the energy of the excitation light PB can be released not only in the Y direction and the −Y direction perpendicular to the surfaces 11 and 12 but also in the X direction and the −X direction parallel to the surfaces 11 and 12. Therefore, the difference between the temperature gradient in the Y direction and the temperature gradient in the X direction can be reduced. As a result, the difference between influence of the thermal lens in the Y direction and influence of the thermal lens in the X direction on the seed light SB is reduced and the deformation of a cross-sectional shape of the optical path of the seed light SB is suppressed, so that it is possible to suppress the discrepancy between the optical path of the excitation light PB and the optical path of the seed light SB and to improve the amplification efficiency.
(2) According to the first embodiment, the length of the long side of the cross section of the laser amplifying medium 1b is two times or more and five times or less of the length of the short side.

Two times or more is preferable because an effect of releasing heat in the X direction and the −X direction, which are the directions of the long side, can be sufficiently improved. Five times or less is preferable because, even if the long side is made longer, the effect of releasing the heat in the X direction and the −X direction is not likely to be improved though the laser amplifying medium 1b is enlarged.
(3) According to the first embodiment, the length of each of the pair of metal blocks 2a and 2b in the X direction is equal to or greater than the length of the long side of the cross section of the laser amplifying medium 1b.

Accordingly, since the heat can be released from the entire two wider opposite surfaces 11 and 12 of the four surfaces 11 to 14 of the laser amplifying medium 1b to the metal blocks 2a and 2b, it is possible to further improve the effect of releasing the heat in the X direction and the −X direction.
(4) According to the first embodiment, the laser amplifier 100 includes the focusing lens FL configured to focus the excitation light PB having passed through the collimating lens CL on the laser amplifying medium 1b. The focusing diameter of the excitation light PB focused by the focusing lens FL is equal to or less than half the length of the short side of the cross section of the laser amplifying medium 1b.

Accordingly, it is possible to separate the optical path of the excitation light PB from the two surfaces 11 and 12 bonded to the metal blocks 2a and 2b, and it is possible to suppress a part of the excitation light PB from being incident on the two surfaces 11 and 12 bonded to the metal blocks 2a and 2b.
(5) According to the first embodiment, the laser amplifier 100 includes the focusing lens FL configured to focus the excitation light PB having passed through the collimating lens CL on the laser amplifying medium 1b. The focusing diameter of the excitation light PB focused by the focusing lens FL is equal to or less than one quarter of the length of the long side of the cross section of the laser amplifying medium 1b.

Accordingly, it is possible to sufficiently separate the optical path of the excitation light PB from the two narrower opposite surfaces 13 and 14 of the four surfaces 11 to 14 of the laser amplifying medium 1b, and it is possible to further improve the effect of releasing the heat generated inside the laser amplifying medium 1b by the energy of the excitation light PB in the X direction and the −X direction.
(6) According to the first embodiment, the laser amplifier 100 includes the focusing lens FL configured to focus the excitation light PB having passed through the collimating lens CL on the laser amplifying medium 1b. The total angular value of the beam divergence of the excitation light PB focused by the focusing lens FL, expressed in radians, is equal to or less than the value obtained by dividing the length of the short side of the cross section of the laser amplifying medium 1b by the length in the Z direction parallel to the optical path axis of the laser amplifying medium 1b.

Accordingly, it is possible to suppress the excitation light PB from spreading and being incident on the two surfaces 11 and 12 bonded to the metal blocks 2a and 2b.
(7) According to the first embodiment, the pair of metal blocks 2a and 2b are atomically diffusion-bonded to the laser amplifying medium 1b.

Accordingly, bonding can be performed at a room temperature by the atomic diffusion bonding, and since residual stress after the bonding is small, deterioration in performance of the laser amplifying medium 1b is suppressed. In addition, since adhesion between the laser amplifying medium 1b and the metal blocks 2a and 2b is high and the interlayers is thin, it is possible to realize the bonding with low thermal resistance, and it is possible to efficiently release the heat from the laser amplifying medium 1b to the metal blocks 2a and 2b.
(8) According to the first embodiment, the pair of metal blocks 2a and 2b are atomically diffusion-bonded to the entire two wider opposite surfaces 11 and 12 of the four surfaces 11 to 14 of the laser amplifying medium 1b.

Accordingly, it is possible to efficiently release the heat from the entire two wider opposite surfaces 11 and 12 of the four surfaces 11 to 14 to the metal blocks 2a and 2b.
(9) According to the first embodiment, the two narrower opposite surfaces 13 and 14 of the four surfaces 11 to 14 of the laser amplifying medium 1b parallel to the optical path axis of the seed light SB are in contact with the gas.

Accordingly, since processing accuracy of the two narrower opposite surfaces 13 and 14 of the four surfaces 11 to 14 is not limited and it is sufficient to ensure the processing accuracy required for the bonding on the two wider opposite surfaces 11 and 12, the laser amplifying medium 1b and the metal blocks 2a and 2b can be reliably bonded.
(10) According to the first embodiment, the laser amplifier 100 includes the heat sinks 3a and 3b in contact with the pair of metal blocks 2a and 2b.

Accordingly, since the heat sinks 3a and 3b are provided separately from the metal blocks 2a and 2b bonded to the laser amplifying medium 1b, the heat that has released from the laser amplifying medium 1b to the metal blocks 2a and 2b can be efficiently discharged from the metal blocks 2a and 2b.
(11) According to the first embodiment, the heat sinks 3a and 3b contain either one of aluminum and copper.

Accordingly, the heat sinks 3a and 3b can be formed of a material which has high thermal conductivity and is inexpensive.
(12) According to the first embodiment, the heat sinks 3a and 3b include the flow path 3c through which the cooling medium passes.

Accordingly, the heat can be efficiently discharged from the heat sinks 3a and 3b by the cooling medium.
(13) According to the first embodiment, the indium foil layers 2d and 2e are provided on the contact surfaces between the pair of metal blocks 2a and 2b and the heat sinks 3a and 3b, respectively.

Accordingly, since indium has high spreadability and can ensure high adhesion between the metal blocks 2a and 2b and the heat sinks 3a and 3b, the heat can be efficiently discharged from the metal blocks 2a and 2b to the heat sinks 3a and 3b.
(14) According to the first embodiment, the heat sinks 3a and 3b are in contact with the first, second, and third surfaces 21, 22, and 23 of each of the pair of metal blocks 2a and 2b, the first surface 21 being on the opposite side to the surface 24 bonded to the laser amplifying medium 1b, and the second and third surfaces 22 and 23 intersecting the X direction, which is the direction of the long side of the cross section of the laser amplifying medium 1b.

Accordingly, since the heat sinks 3a and 3b are in contact with the first, second, and third surfaces 21, 22, and 23, it is possible to efficiently discharge the heat from the metal blocks 2a and 2b to the heat sinks 3a and 3b.
(15) According to the first embodiment, the heat sinks 3a and 3b surround and are in contact with the pair of metal blocks 2a and 2b.

Accordingly, the pair of metal blocks 2a and 2b sandwiching the laser amplifying medium 1b can be integrally held by the heat sinks 3a and 3b.
(16) According to the first embodiment, the heat sinks 3a and 3b include the heat sink 3a, which is the first member located on the X direction side parallel to the long side of the cross section of the laser amplifying medium 1b, and the heat sink 3b, which is the second member located on the −X direction side.

Accordingly, the heat sinks 3a and 3b including the two members surround the metal blocks 2a and 2b, so that the metal blocks 2a and 2b and the heat sinks 3a and 3b can be easily assembled and disassembled.
(17) According to the first embodiment, each of the pair of metal blocks 2a and 2b contains either one of aluminum and copper.

Accordingly, the metal blocks 2a and 2b can be formed of a material which has high thermal conductivity and is inexpensive.

### 3. Embodiment in Which Metal Blocks 2a and 2b Include Flow Path 2c

### 3.1 Configuration and Operation

FIG. 8 is a sectional view of an amplification unit AMP2 in a second embodiment. The configuration of the laser amplifier 100 is the same as that in the comparative example except that the amplification unit AMP2 is used instead of the amplification unit AMP.

The amplification unit AMP2 may not include the heat sinks 3a and 3b or the indium foil layers 2d and 2e. The metal blocks 2a and 2b included in the amplification unit AMP2 include a flow path 2c through which the cooling medium, such as the cooling water, passes. The flow path 2c is connected to the heat exchanger and the pump that are not illustrated. The cooling medium flows through the flow path 2c as indicated by an arrow IN and an arrow OUT to cool the metal blocks 2a and 2b.

In other respects, the second embodiment may be the same as the first embodiment.

### 3.2 Effect

(18) According to the second embodiment, each of the pair of metal blocks 2a and 2b includes the flow path 2c through which the cool medium passes.

Accordingly, since the metal blocks 2a and 2b can be directly cooled, the heat that has released from the laser amplifying medium 1b to the metal blocks 2a and 2b can be efficiently discharged from the metal blocks 2a and 2b.

### 4. Others

### 4.1 Electronic Device Including Interposer IP

FIG. 9 schematically illustrates a configuration of an electronic device. The electronic device illustrated in FIG. 9 includes the integrated circuit chip IC, the interposer IP, and the circuit board CS.

The integrated circuit chip IC is, for example, a chip in which an unillustrated integrated circuit is formed on a silicon substrate. The integrated circuit chip IC is provided with a plurality of bumps ICBs electrically connected to the integrated circuit.

The interposer IP includes an insulating substrate in which a plurality of unillustrated through-holes are formed, and an unillustrated conductor that electrically connects front and back surfaces of the substrate is provided in each of the through-holes. A plurality of unillustrated lands connected respectively to the bumps ICBs are formed on one surface of the interposer IP, and each of the lands is electrically connected to any one of the conductors in the through-holes. A plurality of bumps IPBs are provided on the other surface of the interposer IP, and each of the bumps IPBs is electrically connected to any one of the conductors in the through-holes.

A plurality of unillustrated lands connected respectively to the bumps IPBs are formed on one surface of the circuit board CS. The circuit board CS includes a plurality of terminals electrically connected to the lands, respectively.

FIG. 10 is a flowchart illustrating an electronic device manufacturing method. In S1, laser processing and wire formation on an interposer substrate forming the interposer IP are performed. The laser processing on the interposer substrate includes formation of the through-hole by irradiating the interposer substrate with the laser beam LB. The wire formation includes formation of a conductive film on an inner wall surface of the through-hole formed in the interposer substrate. Through such a process, the interposer IP is manufactured.

In S2, the interposer IP and the integrated circuit chip IC are coupled. This process includes, for example, disposing the bumps ICBs of the integrated circuit chip IC on the lands of the interposer IP and electrically connecting the bumps ICBs and the lands.

In S3, the interposer IP and the circuit board CS are coupled. This process includes, for example, disposing the bumps IPBs of the interposer IP on the lands of the circuit board CS and electrically connecting the bumps IPBs and the lands.

### 4.2 Supplement

The description above is intended as illustration only and not as a limitation. Therefore, it would be obvious to those skilled in the art that various modifications to the embodiments of the present disclosure would be possible without departing from the scope of claims. Further, it would be also obvious to those skilled in the art that embodiments of the present disclosure would be appropriately combined and used.

The terms used throughout the present specification and the scope of claims should be interpreted as non-limiting terms unless clearly described. For example, terms such as “comprise”, “include”, “have”, and “contain” should not be interpreted to be exclusive of other structural elements. Further, indefinite articles “a/an” should be interpreted to mean “at least one” or “one or more.” Further, “at least one of A, B, and C” should be interpreted to mean any of A, B, C, A+B, A+C, B+C, and A+B+C as well as to include combinations of the any thereof and any other than A, B, and C.

What is claimed is:

1. A laser amplifier comprising:
a laser amplifying medium having a cross section in a rectangular shape perpendicular to an optical path axis of seed light;
a pair of metal blocks bonded to two wider opposite surfaces of four surfaces of the laser amplifying medium parallel to the optical path axis, the two surfaces being wider and opposite each other;
an excitation light source configured to output excitation light that excites the laser amplifying medium; and
a collimating lens configured to collimate the excitation light.

2. The laser amplifier according to claim 1, wherein
a length of a long side of the cross section is two times or more and five times or less of a length of a short side of the cross section.

3. The laser amplifier according to claim 1, wherein
a length of each of the pair of metal blocks in a direction of a long side of the cross section is equal to or greater than a length of the long side of the cross section.

4. The laser amplifier according to claim 1, further comprising
a focusing lens configured to focus the excitation light having passed through the collimating lens on the laser amplifying medium, wherein
a focusing diameter of the excitation light focused by the focusing lens is equal to or less than half a length of a short side of the cross section.

5. The laser amplifier according to claim 1, further comprising
a focusing lens configured to focus the excitation light having passed through the collimating lens on the laser amplifying medium, wherein
a focusing diameter of the excitation light focused by the focusing lens is equal to or less than one quarter of a length of a long side of the cross section.

6. The laser amplifier according to claim 1, further comprising
a focusing lens configured to focus the excitation light having passed through the collimating lens on the laser amplifying medium, wherein
a total angular value of beam divergence of the excitation light focused by the focusing lens, expressed in radians, is equal to or less than a value obtained by dividing a length of a short side of the cross section by a length in a direction parallel to the optical path axis of the laser amplifying medium.

7. The laser amplifier according to claim 1, wherein
the pair of metal blocks are atomically diffusion-bonded to the laser amplifying medium.

8. The laser amplifier according to claim 1, wherein
the pair of metal blocks are atomically diffusion-bonded to entirety of the two surfaces.

9. The laser amplifier according to claim 1, wherein
two surfaces of the four surfaces that are narrower and opposite each other are in contact with a gas.

10. The laser amplifier according to claim 1, further comprising
a heat sink in contact with the pair of metal blocks.

11. The laser amplifier according to claim 10, wherein
the heat sink contains either one of aluminum and copper.

12. The laser amplifier according to claim 10, wherein
the heat sink includes a flow path through which a cooling medium passes.

13. The laser amplifier according to claim 10, wherein
an indium foil layer is provided on a contact surface between each of the pair of metal blocks and the heat sink.

14. The laser amplifier according to claim 10, wherein
the heat sink is in contact with first, second, and third surfaces of each of the pair of metal blocks, the first surface being on an opposite side to a surface bonded to the laser amplifying medium, and the second and third surfaces intersecting a direction of a long side of the cross section.

15. The laser amplifier according to claim 10, wherein
the heat sink surrounds and is in contact with the pair of metal blocks.

16. The laser amplifier according to claim 10, wherein
the heat sink includes a first member located on one side in a direction parallel to a long side of the cross section and a second member located on the other side.

17. The laser amplifier according to claim 1, wherein
each of the pair of metal blocks contains either one of aluminum and copper.

18. The laser amplifier according to claim 1, wherein
each of the pair of metal blocks includes a flow path through which a cooling medium passes.

19. A laser apparatus comprising:
a seed laser configured to output pulsed seed light;
a laser amplifying medium having a cross section in a rectangular shape perpendicular to an optical path axis of the seed light;
a pair of metal blocks bonded to two surfaces of four surfaces of the laser amplifying medium parallel to the optical path axis, the two surfaces being wider and opposite each other;
an excitation light source configured to output excitation light that excites the laser amplifying medium; and
a collimating lens configured to collimate the excitation light.

20. An electronic device manufacturing method comprising:
generating a laser beam by a laser apparatus, the laser apparatus including
a seed laser configured to output pulsed seed light,
a laser amplifying medium having a cross section in a rectangular shape perpendicular to an optical path axis of the seed light,
a pair of metal blocks bonded to two surfaces of four surfaces of the laser amplifying medium parallel to the optical path axis, the two surfaces being wider and opposite each other,
an excitation light source configured to output excitation light that excites the laser amplifying medium, and
a collimating lens configured to collimate the excitation light;
manufacturing an interposer by laser processing an interposer substrate with the laser beam;
coupling and electrically connecting the interposer and an integrated circuit chip to each other; and
coupling and electrically connecting the interposer and a circuit board to each other.
